(19) United States
(12) Patent Application Publication
(10) Pub. No.: US 2007/0092641 A1
(43) Pub. Date: Apr. 26, 2007

(54) Optical mirror for lenses

(76) Inventors: Robert Sypniewski, Naperville, IL (US); Edwin Ellefsen, Hinsdale, IL (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/580,367

(22) Filed: Oct. 13, 2006

Related U.S. Application Data
(60) Provisional application No. 60/726,550, filed on Oct. 14, 2005.

(51) Int. Cl. B05D 5/06

(52) U.S. Cl. 427/162

(57) ABSTRACT

A mirrored lens of a plano or ophthalmic type using hardcoats and a topcoat to provide a more durable and easily cleaned.

### BACKGROUND OF THE INVENTION

1. Technical Field

The present invention relates to a piano or ophthalmic sunglass lens with a mirror coating thereon.

2. Background Information

For decades and decades, individuals have worn sunglasses to reduce the amount of sunlight to the eyes when outdoors. One particular type of sunglasses that has grown in popularity is a mirrored lens. However mirrored sunglasses have several disadvantages including lack of durability and lack of ease of cleaning.

### SUMMARY OF THE INVENTION

The inventor has discovered an improved mirrored sunglass lens, and a method of manufacturing. The invention provides a more durable and easier cleaned mirror lens for use as a piano or ophthalmic sunglass lens or other mirrored surface.

The invention is a mirrored lens having a substrate with a hardcoat primer layer, at least one hardcoat layer, a mirror layer and a hydrophobic topcoat. The process of making the invention of a mirrored lens involves etching a substrate, applying a hardcoat primer, curing the hardcoat primer, applying a hardcoat, curing the hardcoat, applying a mirror layer, and applying a hydrophobic topcoat.

### BRIEF DESCRIPTION OF THE DRAWINGS

Preferred embodiments of the invention, illustrative of the best mode in which applicant has contemplated applying the principles, are set forth in the following description and are shown in the drawings and are particularly and distinctly pointed out and set forth in the appended claims.

FIG. 1 is a cross sectional view of the present invention.

### DESCRIPTION OF THE PREFERRED EMBODIMENT

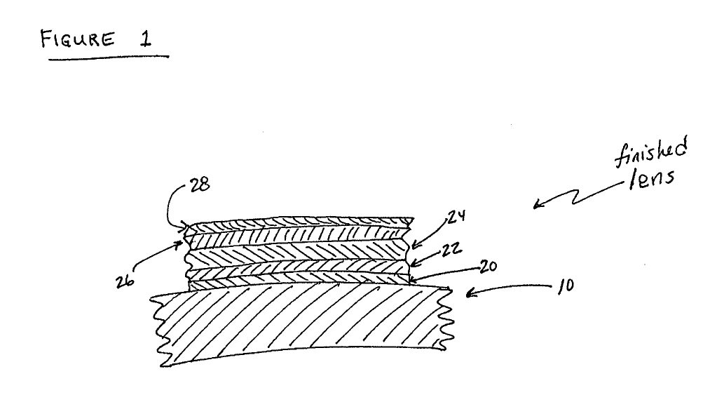

The improved mirrored lens of the present invention is generally shown in FIG. 1, which is more durable and easily cleaned. One application is mirrored sunglasses.

The invention in one embodiment is a mirrored lens which is an uncoated substrate or lens body 10 with a multiple stage hardcoat such as a first hardcoat 22 and a second hardcoat 24 that is harder but typically more brittle than the first hardcoat, a mirror surface 26, and a hydrophobic topcoat 28. In another embodiment, the invention is a lens 10 with a hardcoat primer 20, a multiple stage hardcoat such as a first hardcoat 22 and a second hardcoat 24 that is harder but typically more brittle than the first hardcoat, a mirror surface 26, and a hydrophobic topcoat 28. In yet another embodiment, the invention is a lens 10 with a hardcoat primer 20, a single stage hardcoat hardcoat 22, a mirror surface 26, and a hydrophobic topcoat 28. In yet a further embodiment, the invention is a lens 10 with a mirror surface 26, and a hydrophobic topcoat 28. In other embodiments, the topcoat is of other materials that have similar slippery characteristics to avoid scratches by reducing friction.

In one embodiment, the process of manufacturing a mirrored lens is as follows. The substrate or uncoated lens 10 should preferably be cleaned such as with solvent, detergent or ultrasonic processes for example followed by a rinse such as with water and/or de-ionized water. The lens 10 is then etched such as by a chemical etch which in one process is any caustic etching agent such a potassium hydroxide. A mechanical etch is also an available manner to etch, and plasma or other etching techniques may also be used. An optional hardcoat primer 20 is then applied to lens 10 typically via a dipping process although other methods may be used, cured (thermally or by ultraviolet radiation or other methods). The next step is a dipped hardcoat that is cured such as thermally. The lens 10 is then optionally ion etched in a vacuum chamber such as one used for mirror deposition such as by ion etching where argon ions are bombarded against the lens. A hardcoat of a harder but more brittle material is then evaporated on such as via physical vapor deposition (PVD). Thereafter, a mirror is applied either in the form of a mirror metal only, or as a metal with multiple dielectric layers over metal, or all dielectric layers. Optionally, glue layers, environmental barrier layers and ion guns may be used. Finally, a hydrophobic topcoat is added.

In a preferred embodiment, the process of manufacturing a mirrored lens 10 is as follows. The lens 10 is cleaned with detergent, ultrasonic and de-ionized water. The lens 10 is then etched such as by a chemical etch or other techniques which in one process is any caustic etching agent such a potassium hydroxide. A hardcoat primer 20 is then applied to lens 10 and cured. Thereafter, a thermal cure hardcoat 22 is applied and cured. The lens is then ion etched in a vacuum chamber used for mirror deposition. Another hardcoat such as of SiO₂ may additionally then be evaporated thereon with an electron beam gun (or other methods) and also with or without ion gun assisted deposition. Thereafter, a mirror is applied either in the form of a mirror metal only, or as a metal with multiple dielectric layers over metal, or all dielectric layers. Optionally, glue layers, environmental barrier layers and ion guns may be used. Finally, a hydrophobic topcoat is added.

The invention is unique, novel, and nonobvious by adding successive harder layers via primers and hardcoats to a lens that will be mirrored in order to create a more rigid structure to support the mirror while absorbing the thermal stresses when forces are placed thereon. The invention requires more aggressive etching steps than typical coating processes such as are used in typical anti-reflective coatings or known mirrors. These would involve longer etching, higher temperature etching, and more concentrated chemicals, which are needed to apply and assure adherence of the hardcoats. The hardcoats need additional roughness to adhere to the lens whereby known mirrors do not require this steps, and known anti-reflective coatings may use light etching only as aggressive etching will result in scratches that remain in the lens. The hardcoat successfully fills scratching and surface roughness caused by the aggressive etching while also resulting in a better bond due to the aggressive etching. The hardcoat is typically 5 to 7 microns thick which provides for a stiffer layer than known techniques.

The invention is further unique, novel and nonobvious by providing a slippery surface to the mirror such as a hydrophobic to reduce scratching. It was further discovered that this invention of a hydrophobic topcoat may be applied over most raw or plain lenses, or lenses with existing or known hardcoats such as polarized polycarbonate lenses.

This combination of hardcoats and topcoat is approximately four times more durable and scratch resistant than a typical mirror under an eraser and steel wool scratch test. The process also provides for better adhesion than known processes as determined by accelerated weather tests.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

We claim:

1. A mirrored lens comprising a substrate with a hardcoat primer layer, a thermal cure hardcoat layer, a mirror layer and a hydrophobic topcoat.

2. The mirrored lens of claim 1 wherein the hardcoat layer is a thermal cure hardcoat layer.

3. The mirrored lens of claim 1 wherein the hardcoat layer is a first hardcoat layer, and a second hardcoat layer.

4. The mirrored lens of claim 3 wherein at least one of the hardcoat layers is a thermal cure hardcoat layer.

5. The mirrored lens of claim 3 wherein the first and second hardcoat layers are thermal cure hardcoat layers.

6. The mirrored lens of claim 3 wherein the thermal cure second hardcoat layer is harder but more brittle than the first hardcoat layer.

7. A mirrored lens comprising a substrate with a mirror layer and a hydrophobic topcoat.

8. A process of making a mirrored lens comprising: etching a substrate, applying a hardcoat primer, curing the hardcoat primer, applying a hardcoat, curing the hardcoat, applying a mirror layer, and applying a hydrophobic topcoat.

9. The process of making a mirrored lens as set forth in claim 8 wherein the hydrophobic topcoat is a premium hydrophobic topcoat.

10. The process of making a mirrored lens as set forth in claim 8 wherein the applying a hardcoat is the step of applying a first hardcoat, and wherein the curing the hardcoat is the step of curing the first hardcoat, and further including applying a second hardcoat.

11. The process of making a mirrored lens as set forth in claim 10 wherein the step of applying a second hardcoat is applying a hard transparent material.

12. The process of making a mirrored lens as set forth in claim 11 wherein the transparent material is SiO₂.

13. A process of making a mirrored lens comprising: etching a substrate, applying multiple hardcoats with a curing and etching of the hardcoat in between each application, applying a mirror layer, and applying a premium or regular hydrophobic topcoat.

14. The process of claim 13 wherein etching the substrate is one a chemical, plasma or mechanical etch.

15. The process of claim 13 further comprising applying a hardcoat primer.

16. The process of claim 15 wherein applying the hardcoat primer is one of dipping, thermally curing, or ultraviolet radiation.

17. The process of claim 13 wherein etching the hardcoat is ion etching.

18. The process of claim 13 wherein applying of multiple hardcoats is physical vapor deposition.

19. A process of making a mirrored lens comprising: etching a substrate, applying multiple hard layers with a curing and etching of the hard layer in between each application, applying a mirror layer, and applying a slippery top layer
